(19) United States
(12) Patent Application Publication
(10) Pub. No.: US 2018/0152075 A1
(43) Pub. Date: May 31, 2018

(54) ASSEMBLY STRUCTURE OF DRIVING MOTOR AND INVERTER

(71) Applicants: Hyundai Motor Company, Seoul (KR); Kia Motors Corporation, Seoul (KR)

(72) Inventors: Byungjin YOO, Asan-si (KR); Sangmo RYU, Busan (KR); Kyungseob SHIN, Suwon-si (KR)

(73) Assignees: Hyundai Motor Company, Seoul (KR); Kia Motors Corporation, Seoul (KR)

(21) Appl. No.: 15/795,571

(22) Filed: Oct. 27, 2017

(30) Foreign Application Priority Data
Nov. 30, 2016 (KR) 10-2016-0161780

(51) Int. Cl. H02K 5/22; B60L 11/18; B60L 15/00; H02K 11/33

(52) U.S. Cl. CPC H02K 5/22; B60L 11/1803; B60L 15/007; H02K 11/33; B60L 11/1879; B60Y 2304/03; B60Y 2304/05; B60Y 2200/90; B60L 2210/42

(57) ABSTRACT

An assembly structure of a drive motor and an inverter that integrally assembles an inverter housing to a drive motor housing may include the drive motor housing including an inverter matching surface formed at an upper portion thereof; and the inverter housing including a motor matching surface corresponding to the inverter matching surface, wherein the motor matching surface is formed at a lower portion of the inverter housing, wherein the matching surfaces are formed to cross each other with an angular difference.

### CROSS-REFERENCE(S) TO RELATED APPLICATIONS

The present application claims priority to Korean Patent Application No. 10-2016-0161780, filed on Nov. 30, 2016, the entire contents of which are incorporated herein for all purposes by this reference.

### BACKGROUND OF THE INVENTION

### Field of the Invention

The present invention relates to an assembly structure of a drive motor and an inverter, and, more particularly, to an assembly structure of a drive motor and an inverter disposing the inverter to the drive motor for an eco-friendly vehicle.

### Description of Related Art

Recently, an eco-friendly vehicle including a pure electric vehicle or a fuel cell vehicle has been attracting attention. In the present eco-friendly vehicle, an electric motor configured for driving the vehicle (hereinafter referred to as “a drive-motor”), generating a rotational force using electrical energy, is mounted, instead of an internal combustion engine including a conventional engine.

, to operate the drive-motor, a DC power source of a vehicle battery device may be converted to an AC power source and then supplied to the drive-motor. An apparatus that performs the power conversion operation is called as an inverter.

At present time, there is a demand for the drive motor having high torque and high output in accordance with a trend of high performance of the eco-friendly vehicle. However, an internal compartment of the vehicle in which the drive motor and the inverter are mounted is limited, and thus it is necessary to increase a degree of integration of the vehicle members in the internal compartment.

Therefore, in recent years, there have been an increasing number of cases in which the drive motor and the inverter are integrally formed. The integrated structure of the drive motor and the inverter may improve the degree of integration of the members in the vehicle. In addition, the integrated structure of the drive motor and the inverter is advantageous in terms of a weight reduction, cost reduction, interruption of a common mode voltage generation path, and power consumption since a power cable between the drive motor and the inverter is eliminated.

In the integrated structure of the drive-motor-inverter according to a related art, the inverter is positioned above a housing of the drive-motor, and the drive motor and the inverter are fixed by a separate connection means.

For example, as shown in FIG. 1, the integrated structure according to the related art includes an inverter matching surface 107 of the drive motor housing 101 and a drive motor matching surface 103 of the inverter housing 105 that are parallel to each other.

The drive motor housing 101 includes an inverter matching means on front and rear cover portions. The drive motor matching surface 103 of the inverter housing 105 and the inverter matching surface 107 of the front and rear cover portions of the drive motor housing 101 are parallel to each other and coplanar.

Since the driving-motor matching surface 103 of the inverter housing 105 and the inverter matching surface 107 of the driving-motor housing 101 are parallel to each other and coplanar with each other, there is an advantage that the driving-motor housing 101 and the inverter housing 105 can be easily assembled.

In the above integrated assembly structure of the drive-motor-inverter, lengths of the matching surfaces 103 and 107 are determined according to a size of the inverter housing 105. Thus, an additional spatial constraint occurs when the driving-motor matching surface 103 is relatively greater than a diameter of the driving-motor housing 101.

The information disclosed in this Background of the Invention section is only for enhancement of understanding of the general background of the invention and should not be taken as an acknowledgement or any form of suggestion that this information forms the related art already known to a person skilled in the art.

### BRIEF SUMMARY

Various aspects of the present invention are directed to providing an assembly structure of a drive motor and an inverter which is configured for increasing a degree of integration of members per device volume when a diameter of an inverter housing is relatively greater than that of a length of a drive motor housing.

Various aspects of the present invention are directed to providing the assembly structure of the drive motor and the inverter that integrally assembles the inverter housing to the drive motor housing, including: the drive motor housing including an inverter matching surface formed at an upper portion thereof; and the inverter housing including a motor matching surface corresponding to the inverter matching surface, wherein the motor matching surface is formed at a lower portion of the inverter housing. The matching surfaces may be formed to cross each other with an angular difference.

A matching length between the drive motor housing and the inverter housing may be less than a diameter of the drive motor housing.

The inverter matching surface may be formed by a first plane and a second plane having an angular difference formed at an upper portion of the drive motor housing.

The inverter matching surface may include: a horizontal surface formed at the uppermost portion of the drive motor housing; and an inclined surface inclined downwardly in a first direction from the uppermost portion.

The inclined surface may be separated by an angular difference from the horizontal surface.

The inverter matching surface may be formed at an upper portion of front and rear portions of the drive motor housing.

Various aspects of the present invention are directed to providing the assembly structure of the drive motor and the inverter that integrally assembles the inverter housing to the drive motor housing, including: the drive motor housing including an inverter matching surface formed at an upper portion of front and rear portions thereof; and the inverter housing including a motor matching surface corresponding to the inverter matching surface, wherein the motor matching surface is formed at a lower portion of the inverter housing. The inverter matching surface may include a horizontal surface formed at an uppermost portion of the drive motor housing, and an inclined surface being spaced apart by an angular difference from the horizontal surface at the uppermost portion and being formed to be inclined downwardly.

The horizontal surface and the inclined surface may be disposed to cross each other while maintaining an obtuse angle.

A matching length between the drive motor housing and the inverter housing may be less than the diameter of the drive motor housing.

A cooling passage connected to the motor matching surface may be formed in the inverter matching surface.

The exemplary embodiment of the present invention may configure the motor matching surface of the inverter housing and the inverter matching surface of the drive motor housing coupled with the motor matching surface to be positioned in different planes crossing each other at a predetermined angular difference rather than to be positioned in a same plane parallel to each other.

Therefore, when the total length of the inverter housing is relatively greater than the diameter of the drive motor housing, the exemplary embodiment of the present invention may configure the inverter matching surface of the drive motor housing and the motor matching surface of the inverter housing wherein the matching length between the drive motor housing and the inverter housing is less than diameter of the drive motor housing.

Thus, the exemplary embodiment of the present invention may reduce the inverter matching surface length of the drive motor housing for mounting the inverter to increase the degree of integration of the members in the vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view showing an integrated assembly structure of a drive motor and an inverter according to the related art;

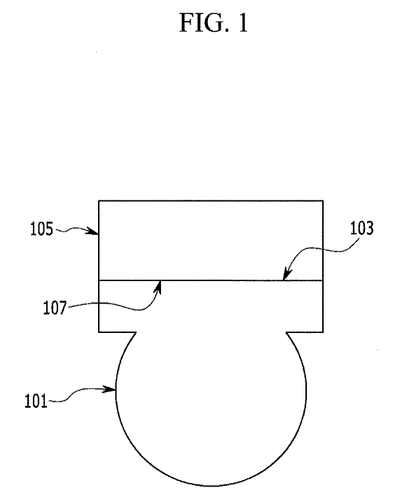

FIG. 2 is a schematic view showing an assembly structure of a drive motor and an inverter according to an exemplary embodiment of the present invention;

FIG. 3 is a front view showing an assembly structure of a drive motor and an inverter according to an exemplary embodiment of the present invention;

FIG. 4 is a rear view showing an assembly structure of a drive motor and an inverter according to an exemplary embodiment of the present invention; and

FIG. 5 is a perspective view illustrating a drive motor housing applied to an assembly structure according to an exemplary embodiment of the present invention.

It should be understood that the appended drawings are not necessarily to scale, presenting a somewhat simplified presentation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Portions having no relation to the description will be omitted to explicitly explain an exemplary embodiment of the present invention.

Furthermore, in the following detailed description, names of constituents, which are in the same relationship, are divided into “the first”, “the second”, and the like, but the present invention is not limited to the order in the following description.

In the specification, unless explicitly described to the contrary, the word “comprise” and variations including “comprises” or “comprising”, will be understood to imply the inclusion of stated elements but not the exclusion of any other elements.

In addition, the terminology including “. . . unit”, “. . . means”, “. . . part”, or “. . . member”, which is disclosed in the specification, refers to a device of an inclusive constituent which performs at least one of the functions or operations.

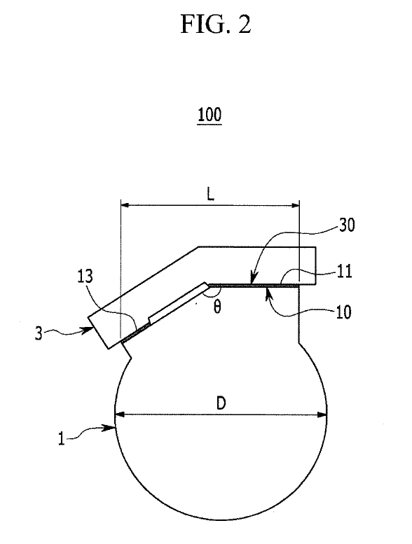

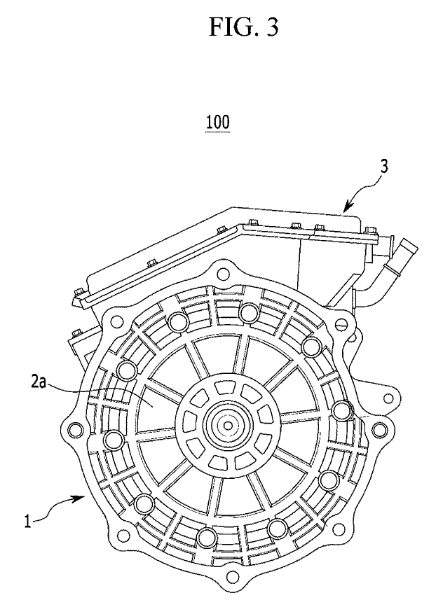

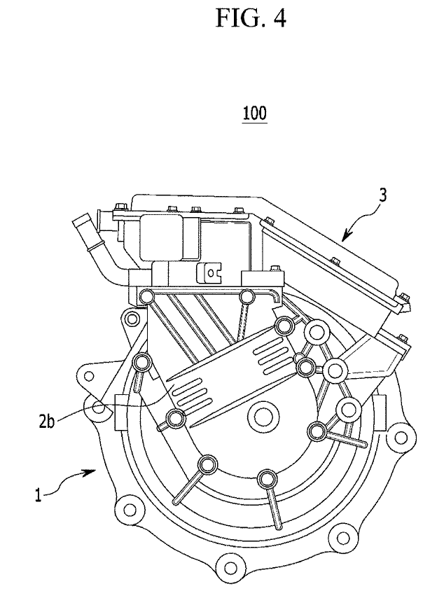

FIG. 2 is a schematic view showing an assembly structure of a drive motor and an inverter according to an exemplary embodiment of the present invention. FIG. 3 is a front view showing the assembly structure of the drive motor and the inverter according to the exemplary embodiment of the present invention. FIG. 4 is a rear view showing the assembly structure of the drive motor and the inverter according to the exemplary embodiment of the present invention.

Referring to FIG. 2, FIG. 3, and FIG. 4, the assembly structure 100 of the drive motor and the inverter may be applied to a drive motor of an environmentally friendly vehicle including an electric vehicle or a fuel cell vehicle, or a drive motor of a hybrid environmentally friendly vehicle using a driving force of an engine and electric power.

For example, the drive motor may include a permanent magnet synchronous motor (PMSM) or a wound rotor synchronous motor (WRSM).

The drive motor includes a drive motor housing 1, a stator internally disposed and fixed within the drive motor house 1 and generating a magnetic flux, and a rotor disposed opposite to the stator via an air gap and rotating about a rotation shaft which is a drive-shaft. The internal of the drive motor housing 1 may mean an internal compartment of the drive motor housing.

The drive motor housing 1 includes covers 2a and 2b disposed at front and rear portions thereof. The covers 2a and 2b may include a cooling channel (hereinafter referred to as a cooling passage) formed internally and includes an internally flowing cooling medium (e.g., a coolant). The internal of the drive motor housing 1 may refer to an internal of the housing wall which is not the internal compartment of the drive motor housing.

An inverter may be disposed at an upper portion of the drive motor housing 1. The inverter may convert direct current (DC) power of a vehicle battery into alternating current (AC) power and supply the AC power to the drive-motor. The inverter may include an inverter housing 3 including an inverter element. The inverter housing 3 may be integrally fixed to upper sides of the covers 2a and 2b of the drive motor housing 1 through a connector.

The exemplary embodiment of the present invention may provide the assembly structure 100 of the drive motor and the inverter which is configured for increasing a degree of integration of members per device volume when a diameter of the inverter housing 3 is relatively greater than a diameter of the drive motor housing 1.

For the above purpose, in the assembly structure 100, an inverter matching surface 10 may be formed at the upper portion of the drive motor housing 1, and a motor matching surface 30 corresponding to the inverter matching surface may be formed at a lower portion of the inverter housing 3.

The inverter matching surface 10 of the drive motor housing 1 may be an assembled accommodating surface or an assembled upper surface for assembling the inverter housing 3 to the upper portion of the drive motor housing 1. The inverter matching surface 10 may be formed at an upper portion of the covers 2a and 2b.

The motor matching surface 30 of the inverter housing 3 may be in close contact with the inverter matching surface 10 of the drive motor housing 1. The motor matching surface 30 may be an assembled lower surface fixed to the inverter matching surface 10 via the connector, and may be formed in a shape corresponding to the inverter matching surface 10 of the drive motor housing 1.

Since the motor matching surface 30 is formed in the shape corresponding to the inverter matching surface 10, only the inverter matching surface 10 will be described in detail and a detailed description of the motor matching surface 30 will be omitted.

When a total length of the inverter housing 3 is relatively greater than a diameter D of the drive motor housing 1, as shown in FIG. 2, the exemplary embodiment of the present invention may configure the inverter matching surface 10 and the motor matching surface 30 wherein a matching length L between the drive motor housing 1 and the inverter housing 3 is less than the diameter D of the drive motor housing 1.

The inverter matching surface 10 and the motor matching surface 30 may be formed to cross each other at a predetermined angular difference θ rather than be parallel to each other as in the related art.

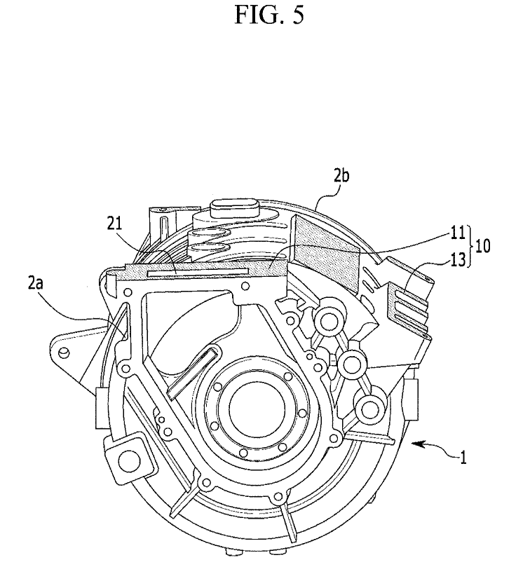

The inverter matching surface 10 may be formed by two planes having an angular difference and formed at an upper portion of the drive motor housing 1, as shown in FIG. 5.

The inverter matching surface 10 may include a horizontal surface 11 formed at an uppermost portion of the drive motor housing 1 and an inclined surface 13 inclined downwardly in a direction from the uppermost portion.

The horizontal surface 11 may be formed to have a predetermined length in a horizontal direction at the uppermost portion of the covers 2a and 2b. The inclined surface 13 may be formed at a side of the uppermost portion of the covers 2a and 2b and may be separated by a predetermined angular difference from the horizontal surface 11.

In more detail, the inclined surface 13 may be separated by a predetermined angular difference from the horizontal surface 11 at the uppermost portion of the covers 2a and 2b, and may be formed inclined downwardly. The horizontal surface 11 and the inclined surface 13 may be disposed crossing each other while maintaining an obtuse angle θ.

The cooling passage 21 connected to the motor matching surface 30 may be formed in the inverter matching surface 10. The cooling passage 21 may be the cooling channel mentioned above as a flow passage for internally flowing the cooling medium.

A cooling passage, or a cooling channel, connected to the cooling passage 21 may be formed in the motor matching surface 30.

The exemplary embodiment of the present invention may configure the motor matching surface 30 and the inverter matching surface 10 with the motor matching surface to be positioned in different planes crossing each other at a predetermined angular difference rather than to be positioned in a same plane parallel to each other.

In more detail, when the total length of the inverter housing 3 is relatively greater than the diameter D of the drive motor housing 1, the exemplary embodiment of the present invention may configure the inverter matching surface 10 and the motor matching surface 30 wherein the matching length between the drive motor housing 1 and the inverter housing 3 is less than the diameter D of the drive motor housing 1.

As a result, the exemplary embodiment of the present invention may reduce the length of the inverter matching surface 10 for mounting the inverter to increase the degree of integration of the members per device volume within the vehicle.

For convenience in explanation and accurate definition in the appended claims, the terms “upper”, “lower”, “up”, “down”, “upwards”, “downwards”, “internal”, “outer”, “inside”, “outside”, “inwardly”, “outwardly”, “internal”, “external”, “front”, “rear”, “back”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is directed to that the scope of the invention be defined by the Claims appended hereto and their equivalents.

What is claimed is:

1. An assembly structure of a drive motor and an inverter that integrally assembles an inverter housing to a drive motor housing, comprising:
the drive motor housing including an inverter matching surface formed at an upper portion thereof; and
the inverter housing including a motor matching surface corresponding to the inverter matching surface, wherein the motor matching surface is formed at a lower portion of the inverter housing,
wherein the matching surfaces are formed to cross each other with an angular difference.

2. The assembly structure of claim 1, wherein a matching length between the drive motor housing and the inverter housing is less than a diameter of the drive motor housing.

3. The assembly structure of claim 1, wherein the inverter matching surface is formed by a first plane and a second plane having an angular difference formed at an upper portion of the drive motor housing.

4. The assembly structure of claim 1, wherein the inverter matching surface includes:
a horizontal surface formed at an uppermost portion of the drive motor housing; and
an inclined surface inclined downwardly in a direction from the uppermost portion.

5. The assembly structure of claim 4, wherein the inclined surface is separated by an angular difference from the horizontal surface.

6. The assembly structure of claim 5, wherein the inverter matching surface is formed at an upper portion of front and rear portions of the drive motor housing.

7. An assembly structure of a drive motor and an inverter that integrally assembles an inverter housing to a drive motor housing, comprising:
the drive motor housing including an inverter matching surface formed at an upper portion of front and rear portions thereof; and
the inverter housing including a motor matching surface corresponding to the inverter matching surface, wherein the motor matching surface is formed at a lower portion of the inverter housing,
wherein the inverter matching surface includes a horizontal surface formed at an uppermost portion of the drive motor housing, and an inclined surface being separated by an angular difference from the horizontal surface at the uppermost portion and inclined downwardly.

8. The assembly structure of claim 7, wherein the horizontal surface and the inclined surface are disposed to cross each other while maintaining an obtuse angle.

9. The assembly structure of claim 7, wherein a matching length between the drive motor housing and the inverter housing is less than a diameter of the drive motor housing.

10. The assembly structure of claim 7, wherein a cooling passage connected to the motor matching surface is formed in the inverter matching surface.
